(19) United States
(12) Patent Application Publication
(10) Pub. No.: US 2014/0374466 A1
(43) Pub. Date: Dec. 25, 2014

(54) METHOD OF ULTRASONICALLY WELDING MULTI-STRANDED MALLEABLE WIRES TOGETHER

(71) Applicant: Branson Ultrasonics Corporation, Danbury, CT (US)

(72) Inventor: Guillermo COTO, Monroe, CT (US)

(73) Assignee: BRANSON ULTRASONICS CORPORATION, Danbury, CT (US)

(21) Appl. No.: 14/293,395

(22) Filed: Jun. 2, 2014

Related U.S. Application Data
(60) Provisional application No. 61/836,882, filed on Jun. 19, 2013.

(51) Int. Cl. B23K 20/10; B23K 20/00

(52) U.S. Cl. CPC B23K 20/10; B23K 20/002; B23K 2201/32; B23K 20/233
USPC 228/102; 228/110.1

(57) ABSTRACT

Multi-stranded wires are clamped between an ultrasonic welding tip and an opposing anvil. The multi-stranded wires are made of a material that is more malleable than copper, or of a material that has a malleability that is substantially the same or greater than the malleability of aluminum. The plurality of multi-stranded wires can be clamped between opposing side surfaces to further form the wire bundle. Ultrasonic energy is applied to a first side of the wire bundle adjacent the ultrasonic welding tip. After termination of ultrasonic energy to the first side, the wire bundle is rotated 180 degrees relative to the anvil and ultrasonic energy is applied to a second side of the wire bundle, wherein the second side is oppositely disposed relative to the first side.

### CROSS-REFERENCE TO RELATED APPLICATIONS

This application claims the benefit of U.S. Provisional Application No. 61/836,882 filed on Jun. 19, 2013. The entire disclosure of the above application is incorporated herein by reference.

### FIELD

The present disclosure relates to methods of ultrasonically welding multi-stranded malleable wires together.

### BACKGROUND

This section provides background information related to the present disclosure which is not necessarily prior art.

Multi-stranded wires are sometimes ultrasonically welded together. Difficulties can arise, however, when such multi-stranded wires have a malleability that is similar to aluminum or other materials that have a malleability that is greater than copper. These difficulties can be particularly problematic when the volume or number of wire strands is relatively large. For example, using typical ultrasonic wire welding devices and methods with wires made using such malleable materials can fail to adequately transfer sufficient ultrasonic energy throughout the entire volume of wire strands. As the ultrasonic tip begins to weld and soften the wires closest to it, then sufficient energy is not induced to the other side of the bundle of wires to create a strong consistent weld throughout the entire bundle of wires. This can result in a weak or partial weld where some of the wire strands fail to be sufficiently welded together.

### SUMMARY

This section provides a general summary of the disclosure, and is not a comprehensive disclosure of its full scope or all of its features, nor should every feature described herein be considered an essential feature of the disclosure.

A method of ultrasonically welding a plurality of multi-stranded wires together includes positioning a plurality of multi-stranded wires between an ultrasonic welding tip and an opposing anvil. The multi-stranded wires are made of a material that is more malleable than copper, or of a material that has a malleability that is substantially the same or greater than the malleability of aluminum. The plurality of multi-stranded wires are clamped between the ultrasonic welding tip and the opposing anvil to form a wire bundle. The plurality of multi-stranded wires can also be clamped between opposing side surfaces to further form the wire bundle. Ultrasonic energy is applied to a first side of the wire bundle adjacent the ultrasonic welding tip. The application of ultrasonic energy to the first side is terminated. The bundle can be allowed to harden and/or the wire bundle is rotated 180 degrees. After termination of ultrasonic energy to the first side, ultrasonic energy is applied to a second side of the wire bundle, wherein the second side is oppositely disposed relative to the first side.

A method of ultrasonically welding a plurality of multi-stranded wires together includes positioning a plurality of multi-stranded wires between an ultrasonic welding tip and an opposing anvil. A user can initiate a control sequence wherein a controller is programmed to automatically cause the ultrasonic welder to automatically carry out a predetermined welding process without further intervention of the operator. The predetermined welding process can include clamping the plurality of multi-stranded wires between the ultrasonic welding tip and the opposing anvil to form a wire bundle. The plurality of multi-stranded wires can also be clamped between opposing side surfaces to further form the wire bundle. Ultrasonic energy is applied to a first side of the wire bundle adjacent the ultrasonic welding tip. The application of ultrasonic energy to the first side is terminated and the sides are automatically unclamped from the wire bundle. The ultrasonic welder can automatically pause, allowing the user to manually rotate the wire bundle 180 degrees, or the ultrasonic welder can automatically rotate the wire bundle 180 degrees, and/or the partially-welded bundle can be allowed to harden. The plurality of multi-stranded wires can again be clamped between the ultrasonic welding tip and the opposing anvil to form a wire bundle. The plurality of multi-stranded wires can also again be clamped between opposing side surfaces to further form the wire bundle. After any such re-clamping steps, ultrasonic energy is automatically applied to a second side of the wire bundle, wherein the second side is oppositely disposed relative to the first side. Once again, the sides can be automatically unclamped from the wire bundle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of an ultrasonic wire welder useful in the methods of the present disclosure.

FIG. 2 is a schematic illustration of the ultrasonic welder of FIG. 1 in a wire clamping configuration.

FIG. 3 is a perspective view of the ends of four stranded wires joined together as a bundle.

FIG. 4 is a side elevation view of the wire bundle of FIG. 3 after ultrasonic energy has been applied to one side of the bundle.

FIG. 5 is a side elevation view of the wire bundle of FIG. 3 after ultrasonic energy has been applied to opposing sides of the bundle.

FIG. 6 is a flow chart of an exemplary control method for ultrasonically welding multi-stranded malleable wires together in accordance with the present disclosure.

Corresponding reference numerals indicate corresponding parts throughout the several views of the drawings.

### DETAILED DESCRIPTION

Example embodiments will now be described more fully with reference to the accompanying drawings.

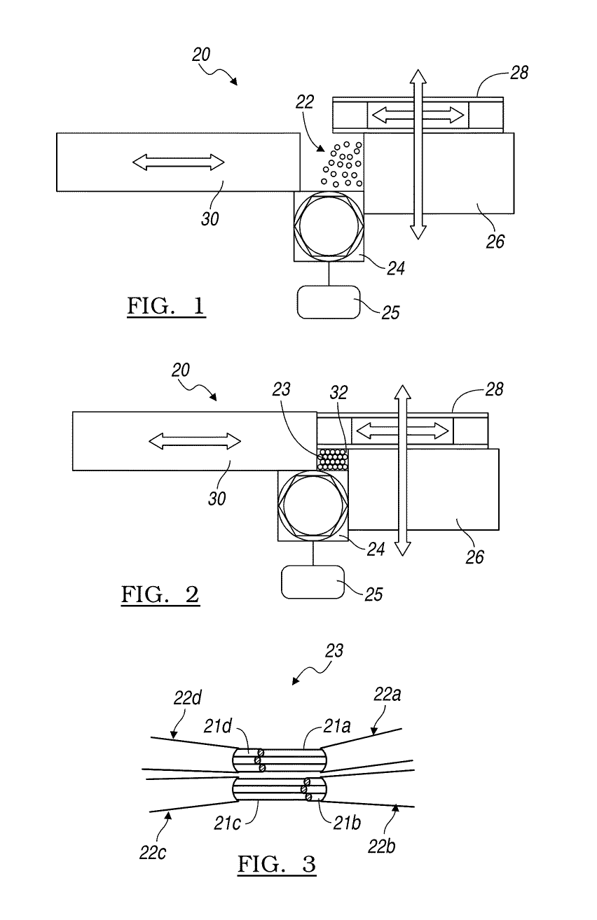

FIG. 1 illustrates an ultrasonic welder 20 for use in welding multi-stranded wires 22 together. Generally, the ultrasonic welder 20 can include an ultrasonic horn welding tip 24 and a guide block 26 that moves vertically relative to the welding tip 24. A controller 25 can be programmed to control the movement of the various components of the ultrasonic welder 20, and the application of ultrasonic energy as described hereinafter. The controller 25 can include a processor and memory (not shown).

Opposing the welding tip 24 is an anvil 28. Opposing the guide block 26 is a gather 30. Bared ends of the wires 22 to be welded together are inserted into the space between the welding tip 24, the anvil 28, the guide block 26, and the gather 30. Vertical relative movement of the welding tip 24 toward the anvil 28, and horizontal relative movement of the gather 30 toward the guide block 26, operates to confine and clamp the bare ends of the wires 22 into a bundle 23 within a welding space 32 as illustrated in FIG. 2.

Exemplary ultrasonic welders 20 are further disclosed in, for example, U.S. Pat. No. 4,782,990, entitled “Portable Gun for Ultrasonically Welding Wires,” which issued to Patrikios et al. on Nov. 8, 1988, and U.S. Pat. No. 4,799,614 entitled “Apparatus for Ultrasonic Welding of Wires,” which issued to Welter et al. on Jan. 24, 1989; both of which are hereby incorporated herein in their entirety.

The bundle 23 of bare wire ends can, in some cases, be formed from two, three, and four, or more stranded wires 22. FIG. 3 illustrates an example wherein four wires 22a, 22b, 22c, and 22d, with bared ends 21a, 21b, 21c, and 21d, respectively, are included in the bundle 23.

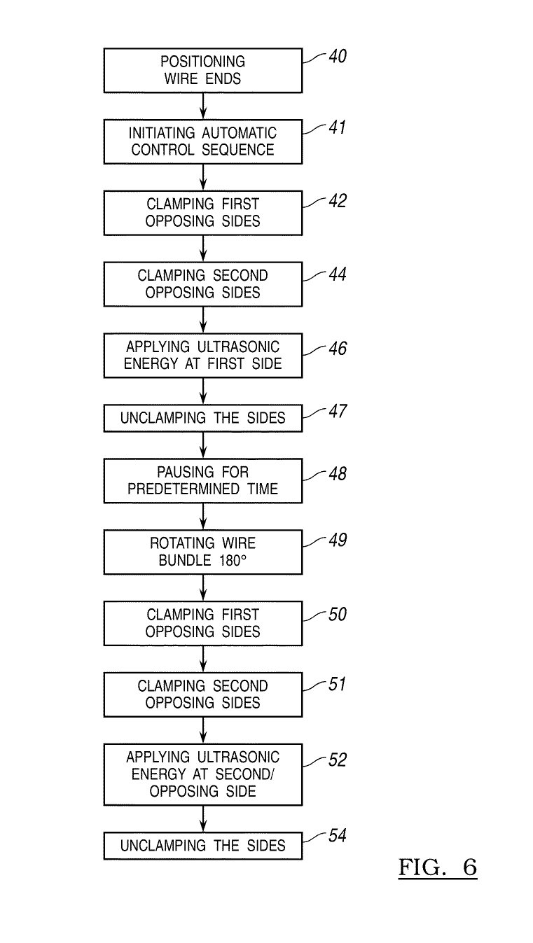

Referring to FIG. 6, the bare wire ends of a plurality of wires 22 to be welded together are positioned between the welding tip 24 and the anvil 28 at box 40. At box 41, a user initiates a control sequence programmed into the controller 25 for automatically performing a predetermined welding process. At box 42, the welding tip 24 can be moved relative to the anvil 28 to contact against opposing sides (e.g., the top and bottom sides in FIG. 2) of the plurality of wires 22. Similarly, at box 44, the gather 30 can be moved relative to the guide block 26 to contact against the remaining opposing sides (e.g., the left and right sides in FIG. 2). As a result, the bundle 23 can be gathered and clamped between the welding tip 24 and the anvil 28 on two opposing sides, and between the guide block 26 and the gather 30 on two other opposing sides.

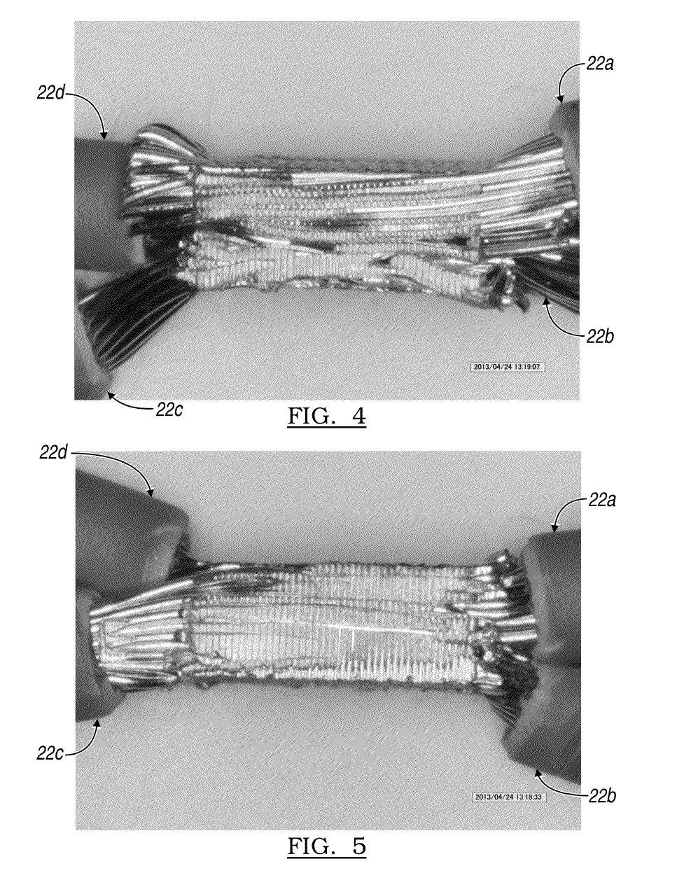

In some cases, the bundle 23 or nugget can have an area X that is the sum of a side surface area (front in FIGS. 4 and 5) plus the top surface area (top in FIGS. 4 and 5) that is up to about 70 mm², wherein the side surface area is 40% of X and the front surface area is 60% of X.

An initial amount of ultrasonic energy can be applied via the welding tip 24 against a first side of the bundle 23 at box 46. At box 47, the partially-welded wire bundle 23 can be released from the clamping forces of the welding tip 24 and anvil 28, and the guide block 26 and gather 30. Then, at box 48, the movement and operation of the ultrasonic welder can pause to allow the user to rotate the partially-welded wire bundle 23 or nugget 180 degrees as indicated at box 49. During this pause the partially-welded wire bundle 23 can, in some instances, be allowed to harden. Alternatively or additionally, the partially welded wire bundle 23 or nugget can be automatically rotated 180 degrees via actuators (not shown) under the programmed control of the controller 25.

Then the first and second opposing sides of the wire bundle 23 or nugget are again clamped at boxes 50 and 51, respectively. As a result, the opposing side (which was previously against the anvil 28) is now clamped against the welding tip 24. Thereafter, the ultrasonic welder is programmed to automatically apply a secondary amount of ultrasonic energy can be applied via a welding tip 24 against the opposing side (which was the bottom side in FIG. 2) of the bundle 23 at box 52. At box 54, the sides of the finally-welded wire bundle 23 can be unclamped, allowing the wires to be removed from the welder 20.

As should be apparent from the above discussion, once the user initiates the control sequence at box 42, the controller 25 can be programmed to cause the ultrasonic welder 20 to automatically perform any or all of the steps of boxes 42, 44, 46, 47, 48, 49, 50, 51, 52, and 54 without any further intervention of the user. In one specific example, the controller 25 can be programmed to cause the ultrasonic welder 20 to automatically perform any or all of the steps of boxes 42, 44, 46, 47, 48, 50, 51, 52, and 54, without any further intervention of the user other than allowing the user to manually rotate the wire bundle 23 at box 49 during the pause of box 48 or otherwise between box 47 and box 50.

An exemplary partially-welded wire bundle 23a or nugget in a state and time between box 46 and box 52 is shown in FIG. 4. A fully-welded wire bundle 23b in a state and time after box 52 is shown in FIG. 6. It can be seen in FIG. 4 that a substantially uniform wire weld is not provided throughout the wire bundle 23a, while in FIG. 5 such a substantially uniform wire bundle 23b exists.

In some cases, the ultrasonic weld joint of wire bundle 23b can have a tensile pull-out strength measured using a pulling gauge that is at least about 1.5 times that of a weld of identical wires formed by applying the same total ultrasonic energy (i.e., same energy over the same total time period) to just one side of the wire bundle. In other cases, the ultrasonic weld joint can have a tensile pull-out strength measured using a pulling gauge that is at least about 1.7 times that of a weld of identical wires formed by applying the same ultrasonic energy to just one side of the wire bundle. In still other cases, the ultrasonic weld joint can have a tensile pull-out strength measured using a pulling gauge that is at least about 2.0 times that of a weld of identical wires formed by applying the same ultrasonic energy to just one side of the wire bundle.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

For example, it will be apparent to those skilled in the art that specific details, or that each specifically identified step need not be employed in every method within the scope of this disclosure. Similarly, the employed method steps, processes, and operations do not necessarily require performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “upper,” “lower,” “top,” “bottom,” “sides,” “left,” “right,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “lower” or “bottom” relative to other elements or features would then be oriented as “upper” or “above” the other elements or features. Thus, the example term “upper” can encompass both an orientation of above and below. The device may be otherwise oriented (rotated 90 degrees or at other orientations) and the spatially relative descriptors used herein interpreted accordingly.

What is claimed is:

1. A method of ultrasonically welding a plurality of malleable multi-stranded wires together comprising:
positioning the plurality of malleable multi-stranded wires between an ultrasonic welding tip and an opposing anvil, wherein the malleable multi-stranded wires are more malleable than copper;
clamping the plurality of multi-stranded wires between the ultrasonic welding tip and the opposing anvil to form a wire bundle;
applying ultrasonic energy to a first side of the wire bundle adjacent the ultrasonic welding tip to partially weld the wire bundle;
terminating the application of ultrasonic energy to the first side;
after the termination of ultrasonic energy to the first side, repositioning the partially welded wire bundle between the ultrasonic welding tip and the opposing anvil to locate a second side of the partially welded wire bundle that is oppositely disposed to the first side adjacent the ultrasonic welding tip;
after the repositioning the partially welded wire bundle, applying ultrasonic energy to the second side.

2. The method of ultrasonically welding a plurality of malleable multi-stranded wires together according to claim 1, wherein the repositioning the partially welded wire bundle comprises rotating the wire bundle 180 degrees.

3. The method of ultrasonically welding a plurality of malleable multi-stranded wires together according to claim 1, wherein the positioning the plurality of malleable multi-stranded wires between an ultrasonic welding tip and an opposing anvil comprises positioning at least three malleable multi-stranded wires.

4. The method of ultrasonically welding a plurality of malleable multi-stranded wires together according to claim 1, wherein the applying ultrasonic energy to a first side and subsequently applying ultrasonic energy to a second side causes the wire bundle to have a pull-out strength measured using a pulling gauge that is at least about 1.5 times that of a weld of identical wires formed by applying the same total ultrasonic energy all to the first side of the wire bundle.

5. The method of ultrasonically welding a plurality of malleable multi-stranded wires together according to claim 1, further comprising:
clamping the plurality of multi-stranded wires between opposing side surfaces to further form the wire bundle.

6. The method of ultrasonically welding a plurality of malleable multi-stranded wires together according to claim 5, wherein the clamping causes the wire bundle to have an area X that is the sum of a side surface area plus a top surface area that is up to 70 mm².

7. The method of ultrasonically welding a plurality of malleable multi-stranded wires together according to claim 6, wherein the clamping causes the wire bundle to have the side surface area corresponding to the first side of the wire bundle that is about 40% of X and the front surface area corresponding to a side adjacent the first side of the wire bundle that is about 60% of X.

8. A method of ultrasonically welding a plurality of malleable multi-stranded wires together comprising:
positioning the plurality of malleable multi-stranded wires between an ultrasonic welding tip and an opposing anvil, wherein the malleable multi-stranded wires have a malleability that is substantially the same or greater than aluminum;
clamping the plurality of multi-stranded wires between the ultrasonic welding tip and the opposing anvil to form a wire bundle, wherein a first side of the wire bundle is adjacent the ultrasonic welding tip;
clamping the plurality of multi-stranded wires between opposing side surfaces to further form the wire bundle;
applying ultrasonic energy to the first side of the wire bundle adjacent the ultrasonic welding tip to partially weld the wire bundle;
terminating the application of ultrasonic energy to the first side;
repositioning the partially welded wire bundle between the ultrasonic welding tip and the opposing anvil, wherein a second side of the partially welded wire bundle that is oppositely disposed to the first side is located adjacent the ultrasonic welding tip;
after repositioning the partially welded wire bundle, applying ultrasonic energy to a second side.

9. The method of ultrasonically welding a plurality of malleable multi-stranded wires together according to claim 8, wherein the repositioning the partially welded wire bundle comprises rotating the wire bundle 180 degrees.

10. The method of ultrasonically welding a plurality of malleable multi-stranded wires together according to claim 8, wherein the repositioning the partially welded wire bundle comprises unclamping the plurality of multi-stranded wires and re-clamping the partially welded wire bundle between the ultrasonic welding tip and the opposing anvil.

11. The method of ultrasonically welding a plurality of malleable multi-stranded wires together according to claim 8, further comprising allowing the wire bundle to harden between the applying ultrasonic energy to the first side and the applying ultrasonic energy to the second side.

12. The method of ultrasonically welding a plurality of malleable multi-stranded wires together according to claim 8, wherein positioning the plurality of malleable multi-stranded wires between an ultrasonic welding tip and an opposing anvil comprises positioning at least four malleable multi-stranded wires.

13. The method of ultrasonically welding a plurality of malleable multi-stranded wires together according to claim 8, wherein applying ultrasonic energy to the first side and subsequently applying ultrasonic energy to the second side causes the wire bundle to have a pull-out strength measured using a pulling gauge that is at least about 1.7 times that of a weld of identical wires formed by applying the same total ultrasonic energy all to the first side of the wire bundle.

14. The method of ultrasonically welding a plurality of malleable multi-stranded wires together according to claim 8, wherein the clamping causes the wire bundle to have an area X that is the sum of a side surface area plus a top surface area that is up to 70 mm².

15. The method of ultrasonically welding a plurality of malleable multi-stranded wires together according to claim 14, wherein the clamping causes the wire bundle to have the side surface area corresponding to the first side of the wire bundle that is about 40% of X and the front surface area corresponding to a side adjacent the first side of the wire bundle that is about 60% of X.

16. A method of ultrasonically welding a plurality of malleable multi-stranded wires together comprising:
positioning a plurality of multi-stranded wires between an ultrasonic welding tip and an opposing anvil, wherein the malleable multi-stranded wires have a malleability that is substantially the same or greater than aluminum;
initiating an automatic welding process comprising:
clamping the plurality of multi-stranded wires between the ultrasonic welding tip and the opposing anvil to form a wire bundle;
applying ultrasonic energy to a first side of the wire bundle adjacent the ultrasonic welding tip to partially weld the wire bundle;
terminating the application of ultrasonic energy to the first side of the wire bundle for a sufficient time to allow the partially welded wire bundle to be repositioned between the ultrasonic welding tip and the opposing anvil to locate a second side of the partially welded wire bundle that is oppositely disposed to the first side adjacent the ultrasonic welding tip;
after passage of the sufficient time, applying ultrasonic energy to the second side of the partially welded wire bundle.

17. The method of ultrasonically welding a plurality of malleable multi-stranded wires together according to claim 16, further comprising:
during the passage of the sufficient time, manually repositioning the partially welded wire bundle to locate the second side adjacent the ultrasonic welding tip.

18. The method of ultrasonically welding a plurality of malleable multi-stranded wires together according to claim 16, wherein the automatic welding process further comprises, during the passage of the sufficient time, automatically repositioning the partially welded wire bundle to locate the second side adjacent the ultrasonic welding tip without manual intervention.

19. The method of ultrasonically welding a plurality of malleable multi-stranded wires together according to claim 16, wherein the sufficient time is great enough to allow the wire bundle to harden prior to the applying ultrasonic energy to the second side.

20. The method of ultrasonically welding a plurality of malleable multi-stranded wires together according to claim 16, wherein the automatic welding process further comprises clamping the plurality of multi-stranded wires between opposing side surfaces to further form the wire bundle.

21. The method of ultrasonically welding a plurality of malleable multi-stranded wires together according to claim 16, wherein the automatic welding process further comprises unclamping the partially welded wire bundle to permit the wire bundle to be rotated 180 degrees and then re-clamping the wire bundle.

22. The method of ultrasonically welding a plurality of malleable multi-stranded wires together according to claim 16, wherein the automatic welding process further comprises unclamping the wire bundle after the applying ultrasonic energy to the second side.

23. The method of ultrasonically welding a plurality of malleable multi-stranded wires together according to claim 16, wherein applying ultrasonic energy to the first side and subsequently applying ultrasonic energy to the second side causes the wire bundle to have a pull-out strength measured using a pulling gauge that is at least about 2 times that of a weld of identical wires formed by applying the same total ultrasonic energy all to the first side of the wire bundle.

24. The method of ultrasonically welding a plurality of malleable multi-stranded wires together according to claim 16, wherein the clamping causes the wire bundle to have an area X that is the sum of a side surface area plus a top surface area that is up to 70 mm².

25. The method of ultrasonically welding a plurality of malleable multi-stranded wires together according to claim 24, wherein the clamping causes the wire bundle to have the side surface area corresponding to the first side of the wire bundle that is about 40% of X and the front surface area corresponding to a side adjacent the first side of the wire bundle that is about 60% of X.

26. A method of ultrasonically welding a plurality of malleable multi-stranded wires together comprising:
positioning a plurality of multi-stranded wires between an ultrasonic welding tip and an opposing anvil, wherein the malleable multi-stranded wires are more malleable than copper;
initiating an automatic welding process comprising:
clamping the plurality of malleable multi-stranded wires between the ultrasonic welding tip and the opposing anvil to form a wire bundle;
clamping the plurality of malleable multi-stranded wires between opposing side surfaces to further form the wire bundle;
applying ultrasonic energy to a first side of the wire bundle adjacent the ultrasonic welding tip to partially weld the wire bundle;
unclamping the partially welded wire bundle to permit the wire bundle to rotate relative to the anvil;
re-clamping the partially welded wire bundle between the ultrasonic welding tip and the opposing anvil to position a second side of the wire bundle that is oppositely disposed to the first side adjacent the ultrasonic welding tip;
after the re-clamping, applying ultrasonic energy to the second side.

27. The method of ultrasonically welding a plurality of malleable multi-stranded wires together according to claim 26, further comprising:
between the unclamping and the re-clamping, manually repositioning the partially welded wire bundle to locate the second side adjacent the ultrasonic welding tip.

28. The method of ultrasonically welding a plurality of malleable multi-stranded wires together according to claim 26, wherein the automatic welding process further comprises, between the unclamping and the re-clamping, automatically repositioning the partially welded wire bundle to locate the second side adjacent the ultrasonic welding tip without manual intervention.

29. The method of ultrasonically welding a plurality of malleable multi-stranded wires together according to claim 26, wherein a time between the applying ultrasonic energy to a first side and the applying ultrasonic energy to the second side is sufficient to allow the wire bundle to harden.

30. The method of ultrasonically welding a plurality of malleable multi-stranded wires together according to claim 27, wherein the automatic welding process further comprises, unclamping the wire bundle after the applying ultrasonic energy to the second side.

31. The method of ultrasonically welding a plurality of malleable multi-stranded wires together according to claim 16, wherein applying ultrasonic energy to the first side and subsequently applying ultrasonic energy to the second side causes the wire bundle to have a pull-out strength measured using a pulling gauge that is at least about 2 times that of a weld of identical wires formed by applying the same total ultrasonic energy all to the first side of the wire bundle.

32. The method of ultrasonically welding a plurality of malleable multi-stranded wires together according to claim 16, wherein the clamping causes the wire bundle to have an area X that is the sum of a side surface area plus a top surface area that is up to 70 mm².

33. The method of ultrasonically welding a plurality of malleable multi-stranded wires together according to claim 24, wherein the clamping causes the wire bundle to have the side surface area corresponding to the first side of the wire bundle that is about 40% of X and the front surface area corresponding to a side adjacent the first side of the wire bundle that is about 60% of X.
